(19) United States
(12) Patent Application Publication
(10) Pub. No.: US 2011/0126035 A1
(43) Pub. Date: May 26, 2011

(54) ENERGY CONSERVATION CONTROL METHOD FOR NETWORK SYSTEM

(75) Inventor: MASAHIKO KANEKO, Hadano (JP)

(73) Assignee: Hitachi, Ltd.

(21) Appl. No.: 12/862,437

(22) Filed: Aug. 24, 2010

(30) Foreign Application Priority Data
Nov. 25, 2009 (JP) 2009-266933

(51) Int. Cl. G06F 1/32; G06F 1/26

(52) U.S. Cl. 713/320

(57) ABSTRACT

In an electric power consumption control method of a plurality of network connection devices connected to a network, the plurality of network connection devices are grouped, and on the basis of the traffic amount of the grouped network connection devices, the grouped network connection devices are controlled by a group unit.

INCORPORATION BY REFERENCE

The present application claims priority from Japanese applications JP 2009-266933 filed on Nov. 25, 2009, the content of which is hereby incorporated by reference into this application.

### BACKGROUND OF THE INVENTION

The present invention relates to a control method, and the like, for network connection devices constituting a network system, and more particular to an electric power consumption control method capable of effectively reducing electric power consumption of the entire network system.

Taking as an example a standard network in a current medium-sized enterprise, if one makes a tentative calculation of the energy consumption amount in the case where several hundreds of terminals such as personal computers (PCs) are connected, the network configuration becomes roughly like in FIG. 1, the equipment configuration working out to two core switches and on the order of ten edge switches.

As for this equipment configuration, duplication is configured with a core switch A 102 and a core switch B 103, connected with a server 101, and wires are connected respectively from each core switch to the edge switches under its command. Further, there are connected clusters of client PCs 107-109 under the command of edge switches 104 to 106. In a normal operating state, the core switch 102 is in an operating state and the core switch 103 is in a standby state, communication from, for example, a client PC cluster 107 to the server 101 being carried out along a path from a client cluster 107 to the edge switch 104, the core switch 102, and the server 101.

The annual electric power consumption with this equipment configuration works out to approximately 25,000 kWh. As for this figure, there is the concern that, accompanying the increase in future communication traffic, it will rise increasingly. Also, from the perspective of a reduction in the amount of electric power consumption, the level of dependence on today's information communication technology and the communication traffic flowing in a corporate network accompanying the same exhibit exponential growth that is continuing. For this reason, electric power consumed by routers constituting a network and network connection devices such as LAN (Local Area Network) switches is also almost attaining a level which cannot be disregarded.

Moreover, in JP-A-2005-198312, there is proposed a method in which, as a response to a request for a reduction in the amount of electric power consumption, there is, regarding the determination of a routing path in the prior art such as of, for example, a wireless communication system, not only taken into account concepts pertaining to a distance between each of the network connection devices, but the electric power needed for data transfer between the network connection devices constituting the wireless communication system is measured and a path is used for which the power consumption needed to transmit data all the way to the connection devices of the transmission network and the connection devices of the destination network becomes a minimum.

### SUMMARY OF THE INVENTION

Since network connection devices in a wireless network move, and since electric power needed for data transfer between the network connection devices fluctuates, it is valid to select a route for which the electric power consumption is at a minimum, but as far as wire line networks are concerned, since positions of the network connection devices are fixed, route variations for carrying out communication are static, the electric power needed for data transfer between the network connection devices also becomes fixed. As a result, as far as wire line networks are concerned, the effect of reducing electric power consumption with the method in the aforementioned JP-A-2005-198312 is small.

Moreover, there is not taken into account any local electric power consumption reduction method corresponding to the fact that the number of network users of, for example, a company department unit or building floor unit network within a network system diminishes. Also, there is not taken into account any electric power consumption reduction method corresponding to carrying out electric power conservation operations in a planned way during time slots in which the number of network users diminishes, such as at night or during holidays. Further, it is not taken into account that it is possible for peripheral network equipments to similarly switch over to an electric power conservation operation (electric power conservation mode) due to the fact that, with an equipment unit “electric power conservation operation function”, the concerned equipment switches over to the electric power conservation operation.

It is an object of the present invention to furnish an energy conservation control method capable of effectively reducing the electric power consumption of the entire network system by adapting to the utilization situation or utilization time slot of the network.

There is used a monitoring device connected with a plurality of network devices, administering the plurality of network devices by group, monitoring the amount of communication traffic for each group, and having a group-specific mode instruction part issuing, in units of the above-described groups, an instruction to switch over to an electric power conservation mode to the above-described network devices.

According to the present invention, it is possible, by grouping a plurality of network connection devices constituting a communication network system, to strive for a reduction in electric power consumption in units of independent groups, without regard to the network utilization situation of other groups, and also, determination as to whether an electric power conservation operation by hand is possible or not, and the accompanying labor of setting network connection devices, are reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is an example of a block diagram of a standard office network;

FIG. 2 is an example of a model diagram of a communication network system controlled with a network monitoring device 201;

FIG. 3 is an example of a network tree model diagram of the communication network system controlled with a network monitoring server 301;

FIG. 4 is an example of a block diagram of the network monitoring server 301;

FIG. 5 is an example of a network tree table 412;

FIG. 6 is an example of a business operation subdivision information table 403;

FIG. 7 is an example of a group-internal host information table 404;

FIG. 8 is an example of a group table 406;

FIG. 9 is an example of a traffic amount table 409 for each group table;

FIG. 10 is an example of a time-of-day fixed instruction information table 410;

FIG. 11 is an example of a sequence chart up to the point where a mode switching instruction is issued by the network monitoring server 301;

FIG. 12 is an example of a flowchart of a fixed instruction mode;

FIG. 13 is an example of a flowchart of a threshold determination mode;

FIG. 14 is an example of a flowchart of a processing for turning off an unnecessary power supply of a host;

FIG. 15 is an example of a display screen display based on an input and output part 413;

FIG. 16 is an example of a host hierarchical table 1600; and

FIG. 17 is an example of a flowchart of a generation processing of the host hierarchical table 1600.

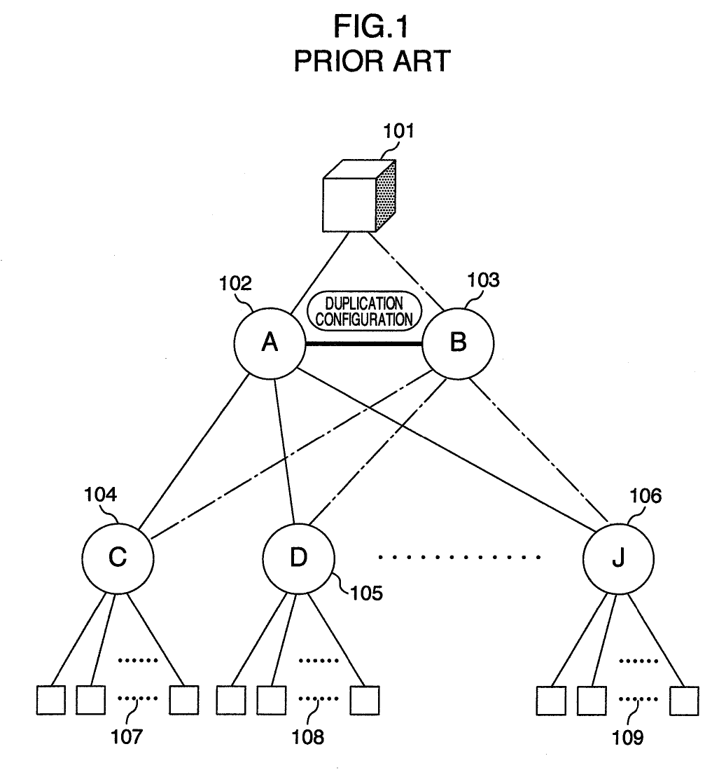

### DETAILED DESCRIPTION OF THE EMBODIMENTS

Hereinafter, preferred embodiments of the present invention will be described with reference to the accompanying drawings of the embodiments.

### First Embodiment

A system of the present invention monitors the entire network by means of a network monitoring device and enables a switch-over to an “electric power conservation operation” with respect to a plurality of network connection devices connected with the network. The expression “electric power conservation operation” here refers to turning off a power supply of unused ports and line interfaces in a network equipment, or alternatively, it is a function of lowering the frequency of the internal operating clock, or the like, to lower electric power consumption, in the case where there is surplus power with respect to communication traffic.

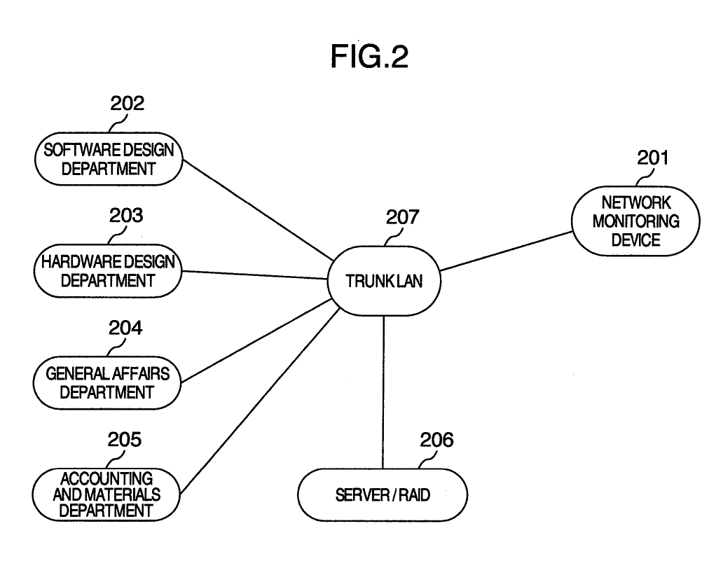

In FIG. 2, there is illustrated a model diagram of a network configuration of Company A, which is an embodiment of a communication network system according to the present invention. As for a network system of Company A, a network monitoring device 201 monitoring the entire system and a software design department 202, a hardware design department 203, a general affairs department 204, an accounting and materials department 205, and a server/RAID (Redundant Array of Independent Disks) 206, indicating the network configuration of each department of Company A, are connected by means of a trunk LAN 207. The network monitoring device 201 is constituted by one or several network monitoring servers. The trunk LAN and the configuration of the network of each department are also constituted by one or several network connection devices.

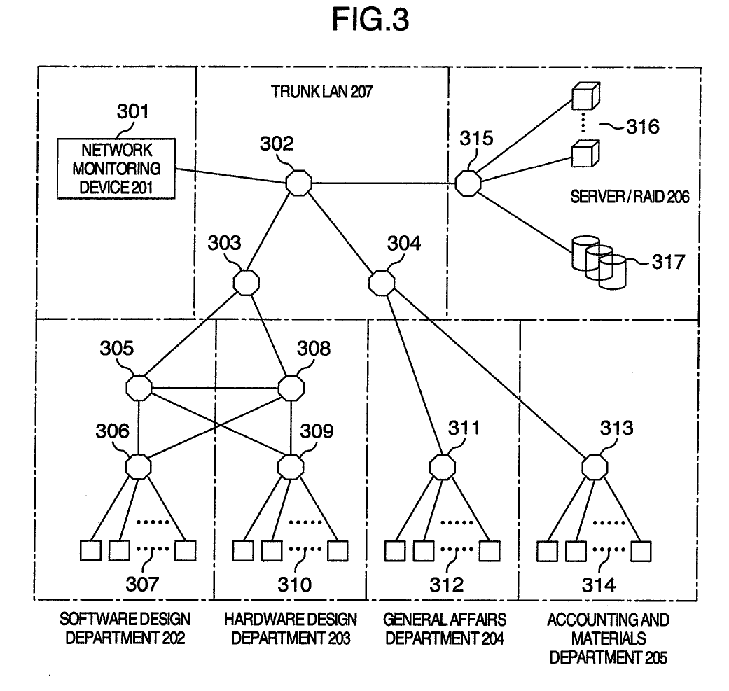

In FIG. 3, there is illustrated a specific configuration of the network system of Company A. The regions delimited by chain lines in the diagram indicate respective departments, equipments being present in the same regions being equipments utilized in the departments indicated by the same regions. For example, in the region of general affairs department 204, there are present a network connection device 311 and a client cluster 312. This indicates that the network connection device 311 and the client cluster 312 are utilized in a business operation of general affairs department 204. Below are the network configurations of each department. The network monitoring device 201 includes one network monitoring server 301 and the trunk LAN 207 is constituted by a network connection device 302, a network connection device 303, and a network connection device 304. The software design department 202 includes a network connection device 305, a network connection device 306, and a client cluster 307. The hardware design department 203 includes a network connection device 308, a network connection device 309, and a client cluster 310. The general affairs department 204 includes a network connection device 311 and the client cluster 312. The accounting and materials department 205 includes a network connection device 313 and a client cluster 314. The server/RAID 206 includes a network connection device 315, a server cluster 316, and a RAID cluster 317. Each equipment is connected by means of the LAN.

Also, it is assumed that a host name which is the same as a reference numeral is assigned to each of the network connection devices. For example, in the case of the network connection device 302, the host name is “302”. The host name corresponds to an IP address, and the network monitoring server 301 is able, by designating the host name, to communicate with each equipment. The host names are, for example, defined by URLs (Uniform Resource Locators) or the like.

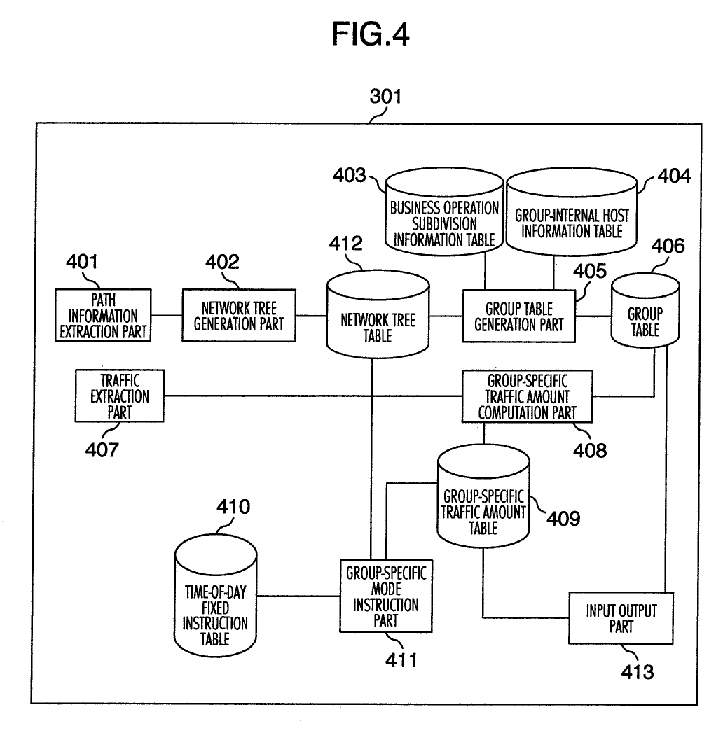

In FIG. 4, a configuration of the network monitoring server 301 is illustrated. The network monitoring server 301 includes: a path information extraction part 401 extracting path information about the network connection devices under administration; a network tree generation part 402 generating a network tree table from the extracted path information; the generated network tree table 412; a business operation subdivision information table 403 storing correspondences between group IDs utilized on the occasion of grouping the network connection devices and business operation subdivisions; a group-internal host information table 404 storing a range of host IP addresses to be stored for each group; a group table generation part 405 generating a group table 406 storing correspondences between groups and hosts; the generated group table 406; a traffic extraction part 407 extracting the traffic of the network connection devices under administration; a group-specific traffic amount computation part 408 computing a total of the extracted traffic for each group; a computed group-specific traffic amount table 409; a time-of-day fixed instruction table 410; a group-specific mode instruction part 411; and an input output part 413 visually representing a state of the network system from the group table 406 and the group-specific traffic amount table 409 and receiving inputs from the administrator.

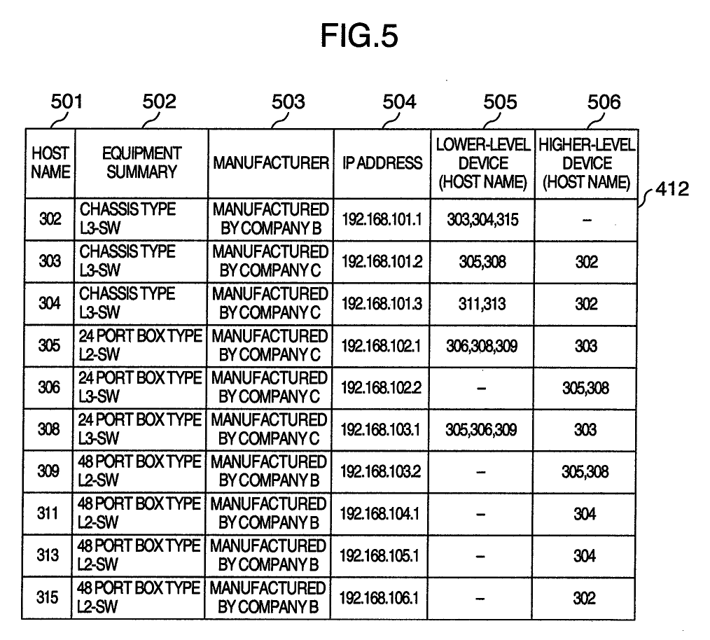

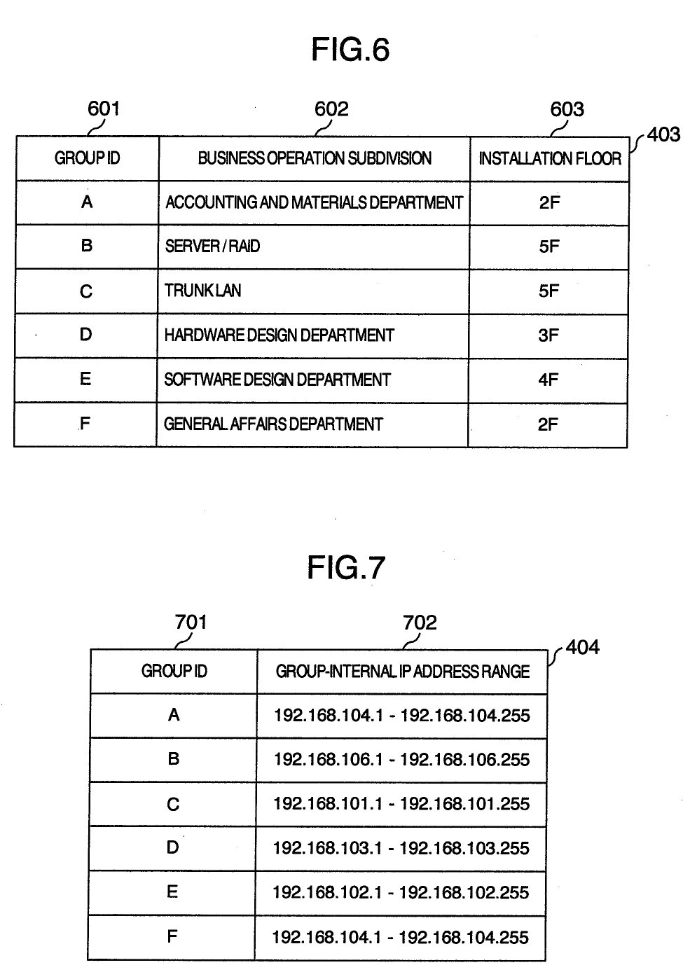

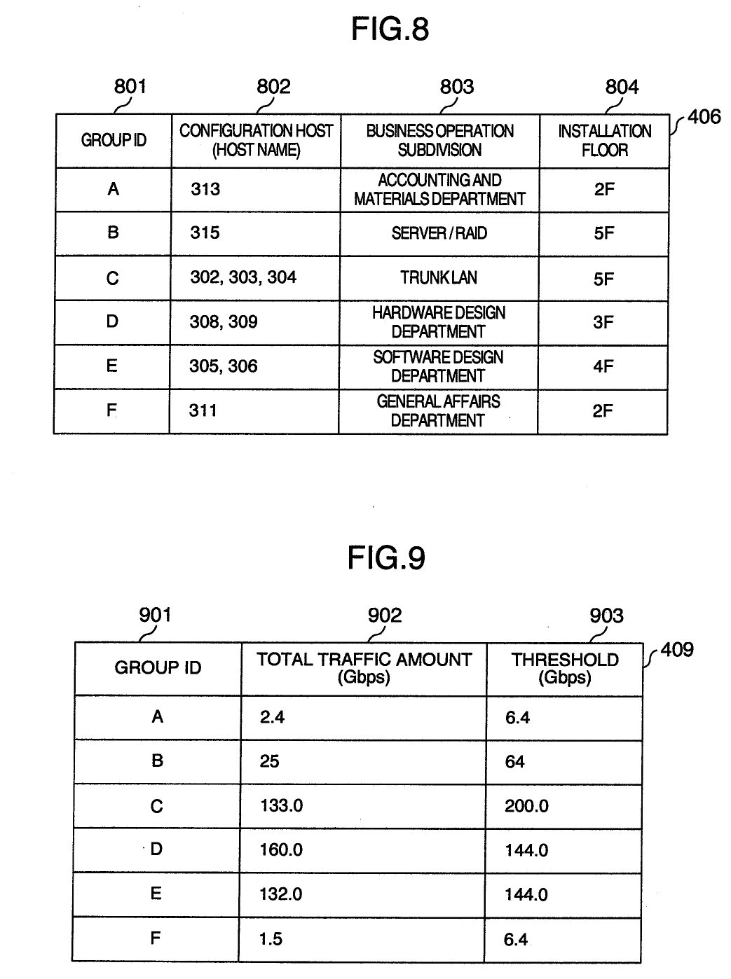

In the network monitoring server 301, there is first extracted path information from the network connection devices with which the path information extraction part 401 is connected by LAN with a simple network management protocol (SNMP). In the path information, there are included IP addresses of the network connection devices, upstream and downstream connection relationships of each network connection device, and other information about the network connection devices. Next, a network tree table 412 illustrated in FIG. 5 is generated from the path information extracted by the network tree generation part 402. Further, the network tree table 412 illustrated in FIG. 5 is a table representing the network tree of Company A illustrated in FIG. 3. Next, the group table 406 illustrated in FIG. 8 is generated by the group table generation part 405 from the network tree table 412, the business operation subdivision information table 403 illustrated in FIG. 6, and the group-internal host information table 404 illustrated in FIG. 7. The group table 406 is a table of each network connection device administered for each business operation such as the software design department 202 or the general affairs department 204, or for each floor. The processing so far is devised so that the network monitoring server 301 can administer each network connection device of Company A in business operation units, floor units, or the like.

Next, the traffic extraction part 407 extracts, from each network connection device within the network, the amount of traffic flowing in the network connection device by a flow statistics protocol. As the flow statistics protocol, sFlow (R) or netFlow (R) may be used. Next, the group-specific traffic amount table 409 is generated from information pertaining to the traffic amount extracted by the group-specific traffic amount computation part 408 and the group table 406. Next, the group-specific mode instruction part 411 consults the group-specific traffic amount table 409 and the time-of-day fixed instruction table 410 and issues an instruction, such as a switch-over to an electric power conservation mode, to the network connection devices for each group unit. A description of the detailed operations will be given subsequently. Also, as for the time-of-day fixed instruction table 410, there are stored instructions as to how the network connection devices within each group are to be operated under the conditions of time of day, day of week, and traffic amount.

In addition, in the present embodiment, one network monitoring server has all the functions necessary for the monitoring, but it is also possible to decentralize the functions to a plurality of servers or devices. Also, a chain of processings from an extraction of the path information and the traffic amount up to the group-specific mode instruction may operate at regular intervals at time intervals designated by the network administrator.

Next, the structure and relationships of the various tables held by the network monitoring server 301 will be described. The network tree table 412 illustrated in FIG. 5 indicates various pieces of information about the network connection devices and hierarchical relationships of the connections among the network connection devices. The network tree table 412 is a table consisting of: a host name column 501 storing the host names conferred on the network connection devices; an equipment summary column 502 storing equipment names, type numbers, and the like, of the network connection devices; a manufacturer column 503 storing manufacturer names of the network connection devices; an IP address column 504 storing the IP addresses granted to the network connection devices; and a lower-level device column 505 and a higher-level device column 506 storing respectively host names of the network connection devices connected to a downstream and upstream from the network connection devices.

The business operation subdivision information table 403 illustrated in FIG. 6 is a table set in advance by the network administrator and is a table in which the business operation subdivisions and floors utilized on the occasion of grouping the network connection devices are stored. The business operation subdivision information table 403 is a table consisting of: a group ID column 601 for grouping and administering by business operation subdivision and installation floor; a business operation subdivision column 602 storing the business operation names or department names utilized by the network connection devices included in the group ID column 601; and an installation floor column 603 storing floors where the network connection devices and the business operations utilizing the network connection devices are situated. In addition, in the present embodiment, the grouping is carried out for each business operation subdivision of Company A, but by changing values of the business operation subdivision column 602, grouping with various subdivisions is possible.

The group-internal host information table 404 illustrated in FIG. 7 is a table which is set in advance by the network administrator and is a table administering the IP addresses allocated for each group. The group-internal host information table 404 consists of a group ID column 701 storing group IDs and a group-internal IP address range column 702 storing ranges of the IP addresses allocated for each group.

The group table 406 illustrated in FIG. 8 is generated, by the group table generation part 405, by consulting the network tree table 412, the business operation subdivision information table 403, and the group-internal host information table 404. The group table 406 administers hosts for each group, making it possible for the network monitoring server 301, by using the group table 406, to issue instructions to a plurality of network connection devices affiliated with the same group. The group table 406 is a table consisting of a group ID column 801 storing group IDs; a configuration host column 802 storing the host names of the network connection devices affiliated with the group; a business operation subdivision column 803 storing the business operation names and department names utilized by the network connection devices affiliated with the group; and an installation floor column 804 storing the floors on which the network connection devices and the business operation departments utilizing the network connection devices are installed.

Next, with reference to FIGS. 5 to 7, there will be made a description about a procedure of generating the group table 406 of FIG. 8. In the case of generating the group ID “A” record of the group table 406, the group ID “A” in the group ID column 601 is first consulted from the business operation subdivision information table 403, and the business operation subdivision “accounting and materials department” and the installation floor “2F” corresponding to the group ID “A” are extracted from the business operation subdivision column 602 and the installation floor column 603, together with the group ID “A”. A new record is generated in the group table 406, storing the Group ID “A”, the business operation subdivision “accounting and materials department”, and the installation floor “2F”. Next, the group ID column 701 and the group-internal IP address range column 702 of the group-internal host information table 404 are consulted and the IP address range “192.168.104.1-192.168.104.255” corresponding to the group ID “A” is extracted.

Next, the IP address column 504 of the network tree table 412 is consulted. When the IP address included in the range of the IP address range “192.168.104.1-192.168.104.255” is stored in the IP address column 504, the corresponding host name of the host name column 501 is extracted. In the case of the present embodiment, the host name “311” corresponds. The extracted host names “311” and “313” are stored in the newly generated group ID “A” record of the group table 406. By repeating the above-described processing for each group ID, the group table 406 is generated.

Next, a description will be made of the group-specific traffic amount table 409 illustrated in FIG. 9. The group-specific traffic amount table 409 consists of a group ID column 901, a total traffic amount column 902 of the network connection devices in the group, and a threshold column 903 with respect to loads due to the communication traffic of the used group-specific network connection devices for utilization in the determination as to whether to switch over the group to the electric power conservation mode or release the electric power conservation mode. The thresholds need to be set in advance by the administrator. In the present embodiment, the total amount of communication traffic of the network connection devices in each group is taken to be an indicator showing the load due to the communication traffic of each group.

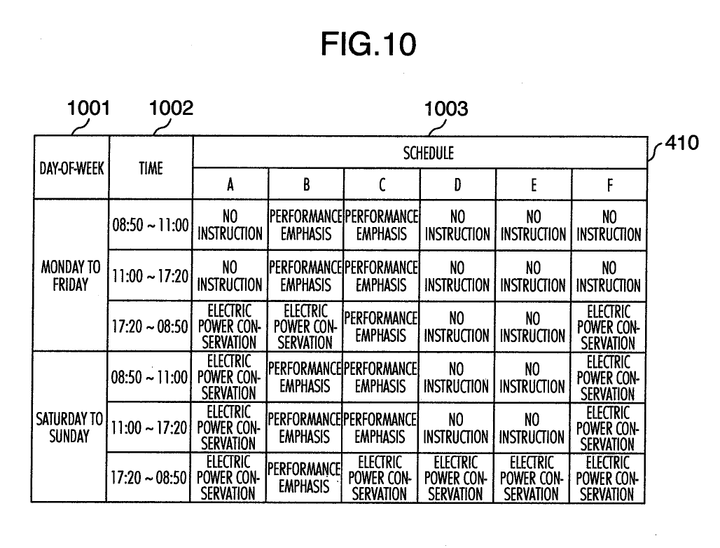

Next, a description will be made of the time-of-day fixed instruction table 410 illustrated in FIG. 10. The time-of-day fixed instruction table 410 consists of a day-of-week column 1001 in which days of the week from Monday to Sunday are included; a time column 1002 in which time slots are included; and group-specific schedule columns 1003 corresponding to days of the week in the day-of-week column 1001 and time slots in the time column 1002. In the group-specific schedule columns 1003, there are stored instructions to each group. There are three types of instructions, “Performance Emphasis”, “Electric Power Conservation”, and “No Instruction”. In the case of “Performance Emphasis”, the network monitoring server 301 requests an operation which emphasizes performance over electric power consumption, with respect to the network connection devices. In the case of “Electric Power Conservation”, the network monitoring server 301 requests an operation which emphasizes restraints on the electric power consumption over the performance, with respect to the network connection devices. In the case of “No Instruction”, it does not perform a fixed operation according to the time and the day of week, but consults the group-specific traffic amount table 409 and, on the basis of the total traffic amount column 902 and the threshold column 903, selects a performance emphasis mode or an electric power conservation mode. For example, since the instruction with respect to Group B of the record for the “Monday to Friday” row of the day-of-week column 1001 and the “11:00-17:20” time slot of the time column 1002 is “Performance Emphasis”, the network monitoring server 301 requests an operation in the performance emphasis mode with respect to the host of Group B.

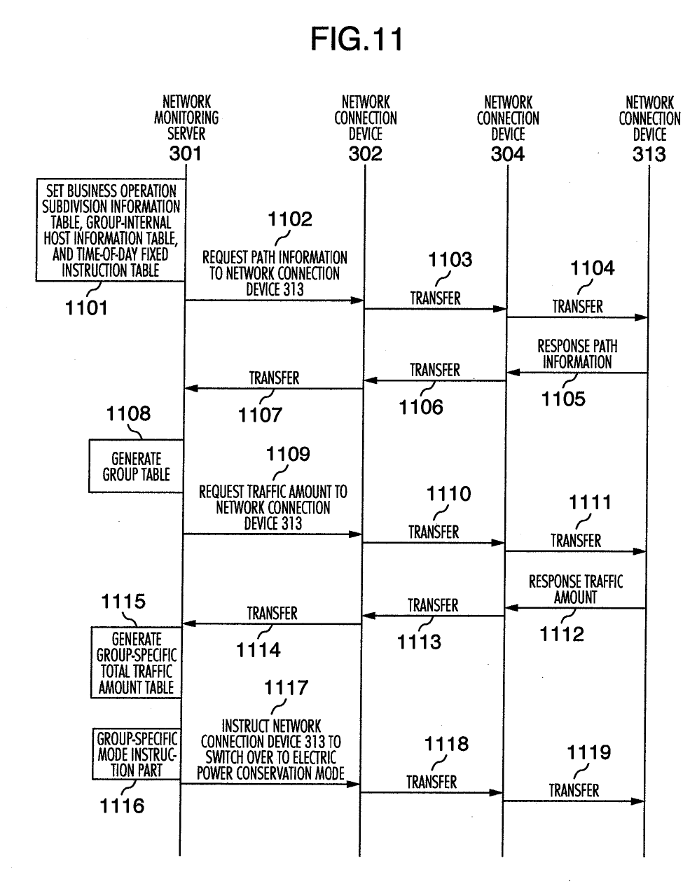

A sequence in which the network monitoring server 301 extracts information from the network connection devices in the network system and up to the point where it issues an instruction to switch over an operating mode is illustrated in FIG. 11. As an example, a description will be made of the case in which an instruction is issued with respect to the Group “A”. First, the system administrator sets in advance the business operation subdivision table 403, the group-internal host information table 404, and the time-of-day fixed instruction table 410 in the network monitoring device 301 (Step 1101). Next, the network monitoring server 301 requests path information from each network connection device under administration (Steps 1102 to 1104). The network connection devices respectively return the path information to the network monitoring server 301 (Steps 1105 to 1107). In addition, in the diagram, only the request message on the path information to the network connection device 313 is illustrated, but the path information requests are also carried out with respect to the other network connection devices. Also, the path information requests to each of the network connection devices need not be carried out simultaneously. Next, the network monitoring server 301 generates the group table 406 from the business operation subdivision table 403, the group-internal host information table 404, the time-of-day fixed instruction table 410, and the network tree table 412 generated from the extracted path information (Step 1108).

Next, the network monitoring server 301, using an SNMP get command or the like, requests a response to a traffic amount with respect to each network connection device in order to examine the total traffic capacity for each group (Steps 1109 to 1111). The network connection devices respectively return the response to the traffic amount to the network monitoring server 301 (Steps 1112 to 1114). In addition, in the diagram, only a response request message to the traffic amount to the network connection device 313 is illustrated, but the responses to the traffic amount are also requested with respect to the other network connection devices. Also, the responses to the traffic amount need not be requested simultaneously with respect to each of the network connection devices. In addition, as the need arises, the responses to the traffic amount may be requested in units of groups. Next, the group-specific traffic amount table 409 is generated on the basis of the received information on the traffic amount and the group table 406 (Step 1115).

Next, the group table 406, the time-of-day fixed instruction information table 410, the group-specific traffic amount table 409 are consulted and an instruction to switch over to an electric power conservation mode is transmitted with respect to the network connection device 313 affiliated with the Group “A” (Steps 1116 to 1119). In addition, in the diagram, there is illustrated only a mode switch instruction message to the network connection device 313 but, as the need arises, mode switch instructions are carried out with respect to the other network connection devices as well. Also, the mode switch instructions need not be carried out simultaneously with respect to each of the network connection devices. The network connection device 313, having received an instruction to switch over to the electric power conservation mode, changes from the operating mode to the electric power conservation mode. For processings such as mode switch instructions, the SNMP may be used, or another protocol may be used.

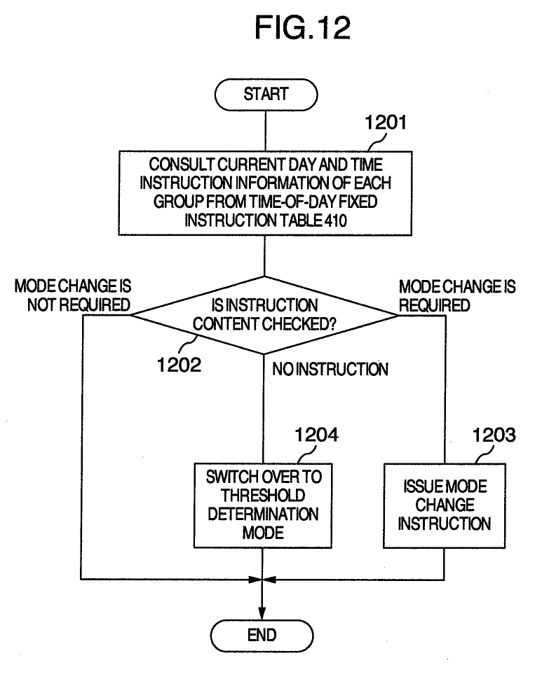

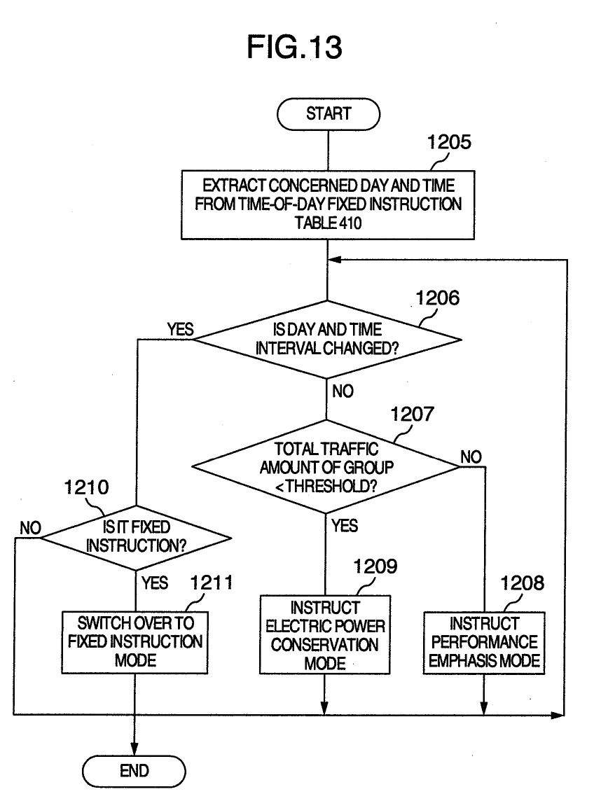

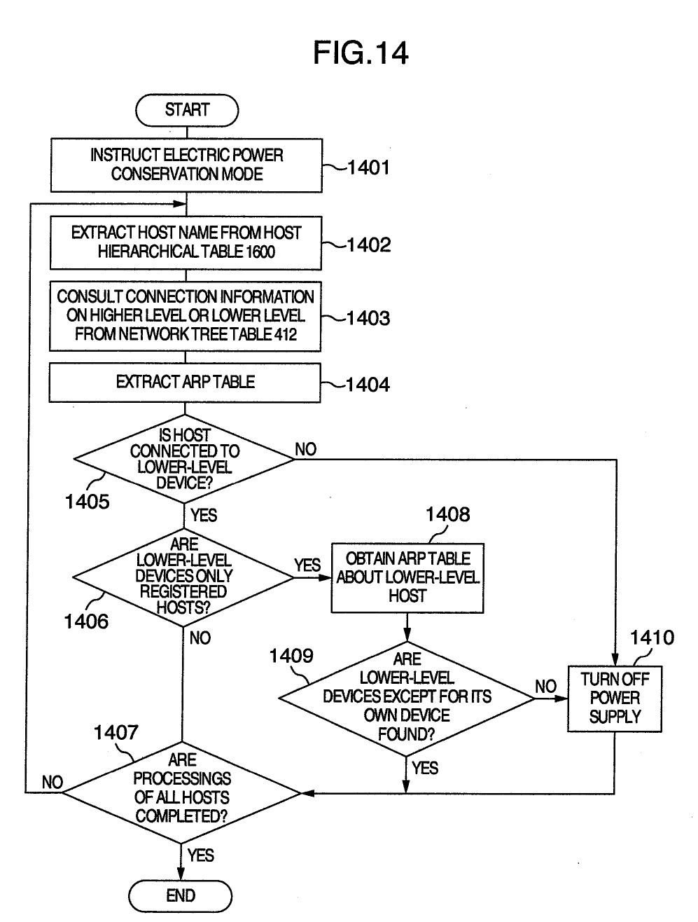

The internal processing of the network monitoring server 301 up to the point where the network monitoring server 301 issues an instruction to the network connection device is illustrated in FIGS. 12, 13, and 14. The fixed instruction mode illustrated in FIG. 12 is a mode in which mode switch instructions are transmitted to each of the network connection devices on the basis of the time-of-day fixed instruction table 410. The threshold determination mode illustrated in FIG. 13 is a mode in which mode switch instructions are transmitted to each of the network connection devices on the basis of the group-specific traffic amount table 409. FIG. 14 is a flowchart illustrating a processing for turning off an unnecessary power supply of a host for each group in the electric power conservation mode instruction processing.

The network monitoring server 301 starts an operation in the fixed instruction mode. When the current time reaches the switch-over timing position of the time slot stored in the time column 1002 of the time-of-day fixed instruction table 410, an operation in the fixed instruction mode of FIG. 12 is started. For example, in the case where the current time is “11:00”, an operation in the fixed instruction mode is started, since it is the timing position at which there is a switch-over from the time slot “8:50-11:00” to the time slot “11:00-17:20” in time column 1002.

In the fixed instruction mode, the group-specific mode instruction part 411 consults the time-of-day fixed instruction table 410 (Step 1201). Next, the instruction mode of each group at the current day and time in the time-of-day fixed instruction table 410 is checked (Step 1202). For each group, a mode change instruction is issued in the case where a mode change is required (Step 1203). For example, in the case of the Group “B”, there is a need to issue a mode switch instruction for day of week “Monday to Friday” when the time slot changes from “11:00-17:20” to “17:20-8:50” in the time-of-day fixed instruction table 410, since the schedule changes from “Performance Emphasis” to “Electric Power Conservation”. In the case where there is no need for a mode change, the process reaches completion without any action. In the case where the schedule is at “No Instruction”, there is a switch-over to the threshold determination mode (Step 1204).

In the threshold determination mode, the group-specific mode instruction part 411 extracts day and time information affiliated with the current time from the time-of-day fixed instruction table 410 (Step 1205). For example, in the case where the current day and time is Tuesday at 13:30, the time slot “11:00-17:20” is extracted. This is because a processing in the threshold determination mode is carried out during the time slot “11:00-17:20”.

Next, the group-specific mode instruction part 411, to check whether the current time has changed day and time intervals, compares it with the previously-extracted day and time information (Step 1206). For example, if the threshold determination mode is entered at 13:30 on Tuesday, the time slot “11:00-17:20” is extracted. Further, when time advances and the current time reaches 18:00, the result is that the current time has changed from the time slot “11:00-17:20” to the interval of the time slot “17:20-8:50”.

In the case where the day and time interval has not changed, since the current processing mode remains the threshold determination mode, the group-specific mode instruction part 411 compares the current total traffic amount of each group and the threshold set for each group (Step 1207). In the case where the current total traffic amount in the group exceeds the threshold, the group-specific mode instruction part 411 issues an instruction to switch over to the performance emphasis mode to the concerned group (Step 1208). Inversely, in the case where the current total traffic amount in the group is lower than the threshold, the group-specific mode instruction part 411 issues an instruction to switch over to the electric power conservation mode to the concerned group (Step 1209). In either event, the process returns to Step 1206.

In the case where the day and time interval has changed, the group-specific mode instruction part 411 checks whether the instructed mode in the time slot in the time-of-day fixed instruction table 410 to which the change has been made is a fixed instruction “Performance Emphasis” or “Electric Power Conservation” (Step 1210). In the case where what is concerned is a fixed instruction, the group-specific mode instruction part 411 switches over to a fixed instruction mode (Step 1211) and completes the threshold determination mode. In the case where what is concerned is not a fixed instruction (in the case of no instruction), the group-specific mode instruction part 411 returns to Step 1206. In addition, operations up to Steps 1201 to 1211 are carried out for each group, but need not be carried out simultaneously.

When the electric power conservation mode is instructed, the network monitoring server 301 performs a processing for turning off an unnecessary power supply of a host. Hereinafter, the above-described processing will be described. Before a processing for turning off the power supply, the network tree generation part 402 generates the network tree table 412 and then, consults the host name column 501, lower-level device column 505, and higher-level device column 506 of the network tree table 412 illustrated in FIG. 5, thus generating a host hierarchical table 1600 illustrated in FIG. 16. The host hierarchical table 1600 is a table obtained by hierarchically rearranging hosts in the order of closeness from the network monitoring server 301 (in the ascending order of the number of the hops), and is used in the case of hierarchically checking whether to turn off the power supply described below.

The host hierarchical table 1600 according to the present embodiment has a structure in which since being nearest to the network monitoring server 301, the host 302 has a hierarchy of “1”. The hosts 303, 304, and 315 are connected to the network monitoring server 301 by two hops via the host 302, and therefore have a hierarchy of “2”. All the hosts are stratified in the same manner as above.

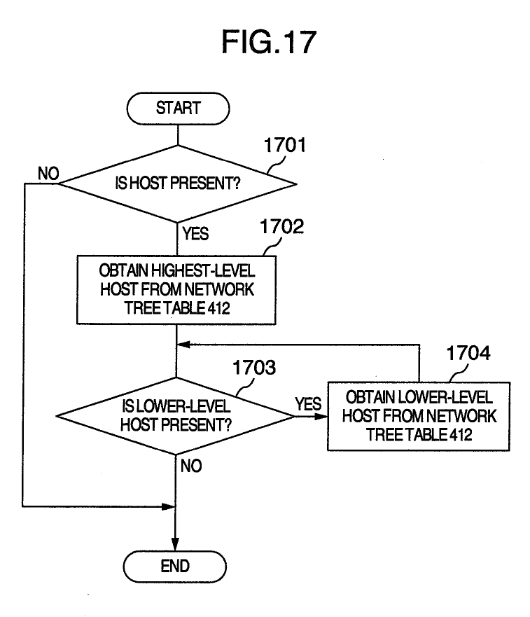

FIG. 17 illustrates a process flow for generating the host hierarchical table 1600. The network tree generation part 402 first consults the network tree table 412 of FIG. 5 and checks whether the host is present (Step 1701). If the host is absent, since the host hierarchical table 1600 fails to be generated, the process ends. If the host is present, a host name of the highest-level host is obtained from the network tree table 412 (Step 1702). In the present embodiment, when the higher-level device column 506 is consulted, since the higher-level device of the host 302 is absent, it can be seen that the host 302 is the highest-level host. Accordingly, the host name column 1602 of the host hierarchical table 1600 is associated with a hierarchy of “1”, and a reference numeral “302” is described therein.

Next, the network tree generation part 402 checks whether there are present lower-level hosts of the host previously inserted into the host hierarchical table 1600 (Step 1703). If the lower-level hosts are absent, since all the hosts are thoroughly investigated, the process ends. If the lower-level hosts are present, lower-level hosts of the previously-processed host are taken out from the network tree table 412 and the processing is carried out in a similar way (Step 1704).

For example, with a focus on the host 302 in the host hierarchical table 1600, the following processing (Step 1703) is carried out. When the higher-level device column 506 of the network tree table 412 is consulted, three records of the host “302” are described therein. This represents that the host 302 has three lower-level devices. According to the present embodiment, the host 302 has three lower-level devices, namely, the hosts 303, 304, and 315. Accordingly, the hosts “303”, 304″, and “315” are associated with a hierarchy of “2” and reference numerals “303”, 304″, and “315” are described in the host name column 1602 of the host hierarchical table 1600. Next, in a similar way, the hosts 305, 308, 311, and 313 as the lower-level devices of the hosts 303, 304, and 315 are associated with a hierarchy of “3” and further the hosts 306 and 309 as their lower-level devices are associated with a hierarchy of “4”.

Next, a power off processing of the host illustrated in FIG. 14 will be described. The group-specific mode instruction part 411 of the network monitoring server 301 performs a processing of FIG. 14 for consulting the host hierarchical table 1600 and turning off an unnecessary power supply of the host. When an instruction to switch over to the electric power conservation mode is issued, the power off processing is started (Step 1401). In addition, the instruction to switch over to the electric power conservation mode in Step 1401 may include both of the instructions at the time of the fixed instruction mode and at the time of the threshold determination mode, or alternatively, may be applied to any one of those.

The group-specific mode instruction part 411 extracts from the host hierarchical table 1600 a host to be processed for checking whether to turn off a power supply (Step 1402). On this occasion, the hosts with the deepest hierarchy in the hierarchy column 1601 are extracted from the host hierarchical table 1600. In the case of the present embodiment, the hosts 306 and 309 with a hierarchy of “4” are extracted.

Next, the group-specific mode instruction part 411 obtains connection information on a higher level or lower level of the host taken out in Step 1402 from the network tree table 412 (Step 1403). In the case of the present embodiment, as can be seen from the network tree table 412, the higher-level devices of the hosts 306 and 309 are the hosts “305” and “308” and on the other hand, a symbol “-” is each described in the lower-level device column of the hosts 306 and 309, and therefore, the hosts 306 and 309 are terminal switches.

Next, the group-specific mode instruction part 411 extracts an ARP table of the hosts taken out in Step 1402 (Step 1404). The ARP table means a contrast table between the IP addresses and the MAC addresses, and when the ARP table is consulted, connection relationships between the host and the other devices can be seen. The real ARP table is obtained through the path information extraction part 401.

Next, the group-specific mode instruction part 411 consults the connection information on a higher level or lower level of the host obtained in Step 1403 and the ARP table extracted in Step 1404, and checks whether the host to be processed is connected to the lower-level devices (the host is connected to the lower-level devices except for the connection to the higher-level devices in the ARP table) in Step 1405. For example, according to the present embodiment, the hosts to be processed are the hosts 306 and 309, and are the terminal switches. Therefore, the lower-level devices are the client clusters 307 and 310, respectively. Accordingly, when not connected to all of these client clusters, the hosts 306 and 309 are not connected to the lower-level devices (for example, a power supply of the client is turned off, or the client is not physically connected to a network).

Next, if the hosts are connected to the lower-level devices in Step 1405, the process goes to Step 1406. On the other hand, if the hosts are not connected to the lower-level devices, the process goes to Step 1410. Here, a description will be made of only a case where the hosts 306 and 309 are not connected to the lower-level devices.

Since the hosts 306 and 309 are not connected to the lower-level devices, the group-specific mode instruction part 411 performs a processing for turning off power supplies of the hosts 306 and 309 (Step 1410). The reason is that since no lower-level device using a network is present, a power supply need not be turned on.

Next, the group-specific mode instruction part 411 checks whether processings of all the hosts are completed (Step 1407). In the present embodiment, since only the processing of the hosts with hierarchies of “1” to “4” is carried out, the process returns to Step 1402. Then, the processing of the host with a hierarchy of “3” at the time of lowering a hierarchy by one is carried out. As described above, until processings of the hosts with all the hierarchies are carried out, the process of FIG. 14 is continued.

The hosts with a hierarchy of “3” are the hosts 305, 308, 311, and 313. Here, only the processings of the hosts 305 and 306 will be described. The above-described processings are carried out up to Steps 1402 to 1405. Next, the hosts to be processed are assumed to be connected to the lower-level devices, and the process goes to Step 1406. In Step 1406, whether the lower-level devices for connection checked in Step 1405 are only lower-level registered hosts (lower-level device column 505 of FIG. 5 corresponding to the hosts to be processed) is checked. For example, the lower-level registered hosts of the host 305 are the hosts 306, 308, and 309.

Here, the lower-level devices for connection of the host 305 are only the hosts 306, 308, and 309, and the process goes to Step 1408.

Next, the ARP table about the lower-level hosts is obtained (Step 1408), and if the lower-level devices for connection except for its own device fails to be found from the obtained ARP table (Step 1409), the group-specific mode instruction part 411 performs a processing for turning off a power supply (Step 1410). The processings subsequent to step 1406 are carried out for coping with a case where both of the hosts with the same hierarchy are connected with each other (the hosts 305 and 308 of FIG. 3 correspond to the above-described case). In the case where both of the hosts with the same hierarchy are connected to each other, when the lower-level device column 505 of FIG. 5 is consulted, it can be seen that both of the devices are mutually recognized as the lower-level device. In this case, when the group-specific mode instruction part 411 previously turns off a power supply of any one of the hosts, one remaining device is necessarily connected to each other in the state where a power supply is turned on. For that reason, a power supply cannot be turned off at all only on the basis of the presence or absence of the connection to the lower-level devices.

As an example, a description will be made of processings in Steps 1406 to 1410 at the host 305 in the case where power supplies of the hosts 306 and 309 are turned off in the previous processing. In Step 1405, since the host 308 is connected as the lower-level device of the host 305, the process goes to Step 1406. When the group-specific mode instruction part 411 consults the ARP table obtained in Step 1404 and the network tree table 412, only the registered host 308 is currently connected to the host 305 (Step 1406). Therefore, the group-specific mode instruction part 411 extracts the ARP table of the lower-level host 308 (Step 1408). Then, as can be seen from the ARP table of the host 308, the host 308 is connected only to the host 305 (Step 1409), and therefore, the group-specific mode instruction part 411 performs a processing for turning off a power supply of the host 305 (Step 1410).

In addition, when the group-specific mode instruction part 411 turns off a power supply once, an administrator may set by hand, or in the time-of-day fixed instruction table 410 of FIG. 10, the “Start-up” for starting the host in which its power supply is turned off. On the occasion, the administrator may set the “Start-up+Performance Emphasis” according to an instruction.

The group-specific mode instruction part 411 performs a processing for turning on or off a power supply of each host by using a remote-controlled power supply control device connected to each host. Or alternatively, the above-described function of remotely controlling a power supply may be provided on its own host. A packet may be transmitted via a network to control a power supply.

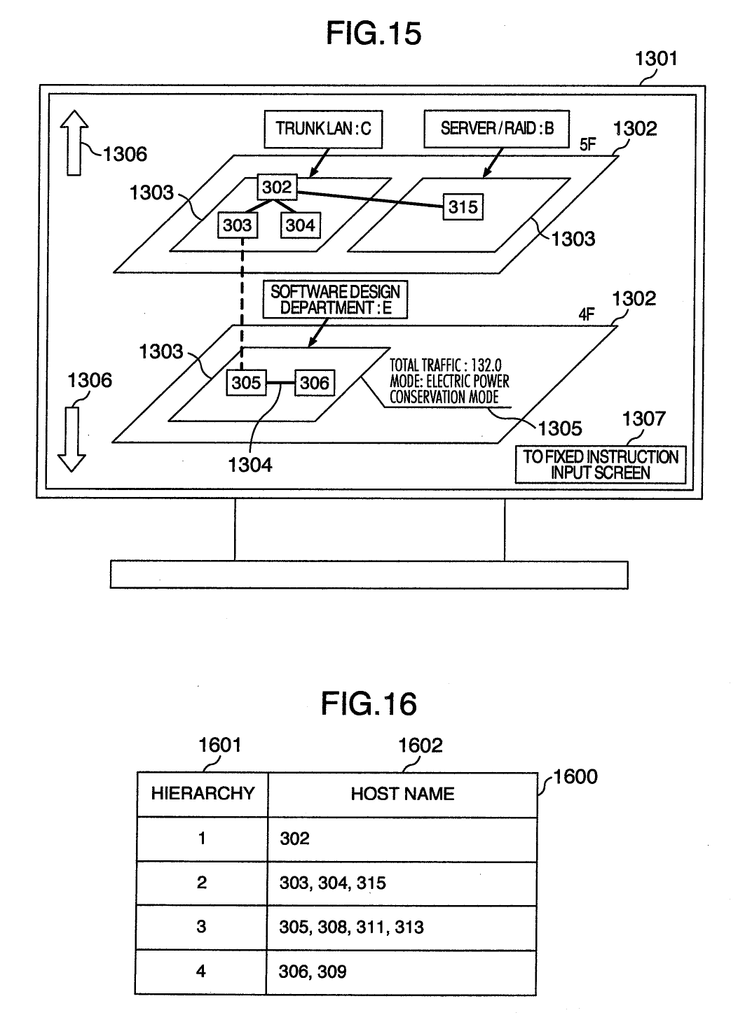

Next, a description will be made of a method of visually representing to the administrator, on a PC display or the like, information about the current traffic amount, and whether the electric power conservation mode is active, about each of the network connection devices, by means of the input output part 413 of the network monitoring server 301, for each floor and business operation subdivision. An example of display content is illustrated in FIG. 15. The display content of the diagram represents the connection relationships of the network connection devices of floors “4F” and “5F”. First, each floor 1302 is displayed on a display 1301. Further, the business operation subdivisions 1303 being present within each floor 1302 and the hosts utilized within each of the same business operation subdivisions are displayed. Then, the connection relationships between each of the hosts are displayed. For example, FIG. 15 shows that network connection devices 305 and 306 are coupled with a line 1304 in 4F. As for the connection relationships, they are displayed not only among the hosts within the same business operation subdivision, the connection relationships on the entire floors or between hosts on different floors also being displayed. It is also possible to display only connection relationships within business operation subdivisions or only connection relationships within the same floor.

Also, for each business operation subdivision (group), there is carried out a display of a state 1305 of the current total traffic and information as to whether an operation is carried out in an electric power conservation mode. Regarding the display of state 1305, it is possible not to display other than necessary information. Also, in case there are too many floor layers or a floor is too large to fit the display, a scroll button 1306 is pushed, mouse scrolling is utilized, or a shortcut key on the keyboard is utilized to make the screen display the same.

The above-described display is displayed by consulting the group table 406 and the group-specific traffic amount table 409. Also, by manipulating directly, by means of a mouse or the like, a model diagram of floors 1302 or business operation subdivisions 1303 represented visually on the display to the administrator, generation of a new business operation subdivision or a manipulation such as switch-over of operating modes is carried out. In addition, it is also possible to move from a diagram display screen to a fixed instruction entry screen. Also, the system may be devised to make it possible to carry out a direct fixed instruction entry on the diagram display screen based on clicking a “TO FIXED INSTRUCTION INPUT SCREEN” button 1307.

According to the present embodiment described above, it is possible to set a switch-over of operating modes all at once with respect to a plurality of network connection devices by grouping the same in logical units such as in business operation units or floor units, rather than in network connection device units. Also, in adapting to the actual situation of network use, an operating mode switch-over, and the like, for each time slot such as “Within Regular Time” and “Outside Regular Time” become possible. Further, by measuring the actual traffic amount of each group, operations such as switching over to an electric power conservation mode during a time slot in which there are few data transfers in a certain group are possible.

Also, by visual display, to the administrator, of the network system for each floor or business operation subdivision, the administration becomes simple and the intuitive manipulation also becomes possible.

Further, in the present embodiment, the network monitoring device may be represented as a monitoring device and the network connection devices as network devices. Also, host names may be represented as device identifiers and group IDs as group identifiers. Also, the business operation subdivision information table, the group-internal host information table, the group table, and the time-of-day fixed instruction table may be simply represented as an N-th storage part. In addition, the group-specific traffic amount computation part may be represented as a group-specific load amount computation part.

It should be further understood by those skilled in the art that although the foregoing description has been made on embodiments of the invention, the invention is not limited thereto and various changes and modification may be made without departing from the spirit of the invention and the scope of the appended claims.

1. A monitoring device connected with a plurality of network devices, comprising;
an administrating part which administrates the plurality of network devices by group and monitors the amount of communication traffic for each group; and
a group-specific mode instruction part which issues, in units of the above-described groups, an instruction to switch over to an electric power conservation mode to the above-described network devices,
wherein the group-specific mode instruction part turns off a power supply of the network device having no connection device downstream at the time of issuing an instruction to switch over to the electric power conservation mode.

2. The monitoring device according to claim 1, further comprising:
a path information extraction part which obtains, from the plurality of network devices, information including device identifiers uniquely identifying the respective network devices; and
a first storage part in which ranges of group identifiers uniquely identifying the groups and device identifiers corresponding to the concerned group identifiers are set in advance; and
wherein the group-specific mode instruction part generates a second storage part in which the correspondences between the group identifiers and the obtained device identifiers are stored by consulting the device identifiers obtained by the path information extraction part and the first storage part.

3. The monitoring device according to claim 2, wherein:
the group-specific mode instruction part, in the case of issuing, in group units, an instruction to switch over to the electric power conservation mode to the network devices, consults the second storage part, looks up the device identifiers corresponding to the group identifiers of groups which are to be switched over to the electric power conservation mode; and issues an instruction to switch over to the electric power conservation mode to the network devices indicated by the looked-up device identifiers.

4. The monitoring device according to claim 3, further comprising:
a third storage part which associates the group identifiers with the number of hops from the monitoring device to the network device to store them on the basis of information obtained from the path information extraction part; and
wherein the group-specific mode instruction part consults the third storage part and turning off a power supply from the network device with the large number of hops.

5. The monitoring device according to claim 3, wherein:
the path information extraction part obtains, from a network device to turn off a power supply, a first connection information unit for identifying a connection state between the network device to turn off a power supply and the other devices; and
the group-specific mode instruction part consults the first connection information unit and, if the network device to turn off a power supply is not connected to the other devices, turns off a power supply of the network device to turn off a power supply.

6. The monitoring device according to claim 5, wherein the group-specific mode instruction part consults the first connection information unit; if the network device to turn off a power supply is connected to the other devices, causes the path information extraction part to obtain a second connection information unit from the other devices; consults the second connection information unit; and if every device except the network device to turn off a power supply is not connected to the other devices, turns off a power supply of the network device to turn off a power supply.

7. The monitoring device according to claim 5, wherein the connection information is stored in an ARP table.

8. The monitoring device according to claim 3, further comprising: a fourth storage part which stores, for each time slot, an instruction as to whether to cause the network devices corresponding to the groups to operate in an electric power conservation mode or not; causes the group-specific mode instruction part to consult the fourth storage part; if there are present the groups for which an instruction is set to switch over to the electric power conservation mode at the current time, consults the second storage part; and issuing an instruction to switch over to the electric power conservation mode to the network devices corresponding to the groups for which an instruction to switch over to the electric power conservation mode is set.

9. The monitoring device according to claim 8, wherein the fourth storage part stores information about the day of the week and, for each day of the week and further for each time slot, an instruction as to whether to cause the group to operate in an electric power conservation mode or not; causes the group-specific mode instruction part to consult the fourth storage part; if there are present the groups for which an instruction is set to switch over to the electric power conservation mode, consults the second storage part; and issues an instruction to switch over to the electric power conservation mode to the network devices corresponding to the groups for which an instruction to switch over to the electric power conservation mode is set.

10. The monitoring device according to claim 8, further comprising:
a traffic amount extraction part which consults the second storage part for each of the groups and obtains information pertaining to the communication traffic amount from the network devices; and
a group-specific load computation part which computes information pertaining to the communication traffic amount obtained for each of the groups and the load due to communication traffic for each of the groups from the second storage part,
wherein the group-specific mode instruction part determines whether the load is lower or not than a threshold set in advance, and issuing an instruction to switch over to the electric power conservation mode to the network devices corresponding to the groups in which the load is lower than the threshold.

11. The monitoring device according to claim 9, wherein:
the fourth storage part stores a starting instruction in the case where there is present a network device in which a power supply is turned off; and
the group-specific mode instruction part consults the concerned fourth storage part; and if there is present the group in which the starting instruction is set, consults the second storage part, and issues the starting instruction to the network device corresponding to the group in which an instruction to switch over to the electric power conservation mode is set.

12. The monitoring device according to claim 11, wherein an external power supply control device which controls a power supply of the network device is connected to the network device; and
the starting instruction to the network device is carried out through the external power supply control device fixed to the concerned network device.

13. The monitoring device according to claim 11, wherein the starting instruction to the network device is carried out by transmitting a packet to the concerned network device.
